(19) United States
(12) Patent Application Publication
(10) Pub. No.: US 2005/0129920 A1
(43) Pub. Date: Jun. 16, 2005

(54) Three dimensional continuous contoured pad cutting and laminating process

(76) Inventors: Michael Levesque, Cambridge (CA); Steven G. Brown, Birmingham, MI (US); Guy W. Boitos, Bloomfield, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/983,813

(22) Filed: Nov. 8, 2004

Related U.S. Application Data
(60) Provisional application No. 60/517,677, filed on Nov. 6, 2003.

(51) Int. Cl. B32B 7/02; B32B 3/10

(52) U.S. Cl. 428/304.4; 428/131; 428/218

(57) ABSTRACT

A method of fabricating a laminated layer includes the step of supplying first and second layer of a polymeric material, followed by serially removing blanks of the polymeric material from the first layer to produce an excess and useable layers. The blanks of the polymeric material are disposed serially along and fused to the second layer to provide a contoured pad.

### BACKGROUND OF THE INVENTION

1. Field of the Invention

The subject invention relates to a sound insulating part, and more particularly to a process of making the sound insulating part including a plastic layer and a contoured pad made of resilient synthetic foam for various industrial applications.

2. Description of the Prior Art

Acoustical insulation materials are known to be used in various industrial applications. For example, vehicle manufacturers use acoustical insulation in vehicle doors, headliners, and the like. Generally, most contemporary automobiles include engine and passenger compartments and a steel firewall, i.e. plenum, which separates an engine compartment from a passenger compartment. Wires, wire harness, HVAC lines connected to the engine, and other components, located in the engine compartment running through the firewall, are enclosed in steel and plastic tubes of different length and widths. The wires, wire harness, and other components located in the engine compartment are fastened to the fire-wall, thereby forming plurality of projections and ribs extending inwardly from the fire wall to the passenger compartment.

During operation, the engine and related components produce undesirable noise. In addition to the noise produced by the running engine, there other sources of noise that may include or be affected by tire construction, noise produced by exhaust manifold connected to the engine, chassis and suspension noise, and the like. To reduce the transmission of sound from the engine compartment through the firewall and into the passenger compartment, the contemporary automobiles include a sound barrier mat, padded carpet, headliners, and the like. The sound barrier mat is typically molded as a single piece of an elastomeric material of substantially uniform thickness.

The sound barrier mat has inner and outer surfaces. The inner surface is mounted to the firewall and generally extends along the entire surface of the firewall. The inner surface of the sound barrier mat includes a plurality of void portions of various configurations and sizes to mate with and to engage the complementary projections and ribs formed by aforementioned components located in the engine compartment and fastened to the fire-wall. The outer surface of the sound barrier mat faces the passenger compartment and generally contacts with a bottom surface of a vehicle carpet. The sound barrier mat also extends beyond the carpet to an upper portion of the firewall behind an instrument panel.

The engine noise reduction art is replete with various designs and methods of fabricating acoustic and decorative mats used in a modern automotive industry. These designs include forming the mats having at least two layer of a polymeric material, wherein one of the layers includes a foamed polymeric material, such as, for example, polyurethane. The layers may include an adhesive tape or composition between one and the other and are placed into a molding apparatus to receive a three-dimensional shape to mate with the inner surface of the firewall. Various methods have been utilized to form the void portions of various configurations in one of the layers of the mat to mate with and to engage the complementary projections and ribs formed by aforementioned components located in the engine compartment and fastened to the fire-wall.

One of the methods currently used in the art is a method of forming the void portions by “burning out” the foamed polymeric material to define the void portions of various configurations and sizes to mate with and to engage the complementary projections and ribs. Hence practicable, this method proves to be non-cost effective due to amount of labor hours spent to fabricate the mat. In addition, the odor and smoke of “burned” foamed polymeric material is hard to be evaporated and stays in a manufacturing facility for a considerable amount of time, making work environment unpleasant. In addition, the “burning out” process is difficult to control, thereby burning larger portion than required creating extra gaps between the foamed polymeric material and the complementary projections and ribs, engaged therein.

There is a constant need in the area of fabricating a sound insulating mats including a plastic layer and a contoured pad made of resilient synthetic foam to provide an improved method of fabricating a sound insulating mat that will eliminated aforementioned problems known to the modern automotive industry.

### SUMMARY OF INVENTION

A method of fabricating a pad of a polymeric material having three-dimensional contour includes the step of supplying a first layer of a first polymeric material and the step of supplying a second layer of a second polymeric material. The next step of the present method includes serially removing blanks of the first polymeric material from the first layer to produce an excess layer and a useable layer having the blanks extending therefrom. The method further includes the step of collecting the excess layer, followed by the step of disposing the blanks of the first polymeric material serially along the second, i.e. lower layer of the second polymeric material. The useable layer of the first polymeric material is disposed upon the second layer of the second polymeric material. The useable layer of the first polymeric material is fused to the second layer of the second polymeric material to fabricate a contoured layer.

An advantage of the present invention is to provide a method of fabricating a pad of a polymeric material having three-dimensional contour that is non-cost effective due to the amount of labor hours spent to fabricate the mat.

Another advantage of the present invention is to provide “odor-free” and “smoke-free” environment in the manufacturing facility by substituting a “burning-out” process of forming various apertures in a foamed polymeric material by mechanically removing a used polymeric material from the foamed polymeric material to form these complementary apertures for projections and ribs, engaged therein.

Still another advantage of the present invention is to provide the process of forming the apertures that is easy to control and provides gap-free engagement between the foamed polymeric material and the complementary projections and ribs, engaged therein.

### BRIEF DESCRIPTION OF THE DRAWINGS

An advantages of the present invention will be readily appreciated as the same becomes better understood by reference to the following detailed description when considered in connection with the accompanying drawings wherein:

FIG. 1 is a front view of a process of making the sound insulating pad including a plastic layer and a contoured pad made of resilient synthetic foam;

FIG. 2 is a front view of die and pressure rollers of a cutting mechanism, wherein the die and pressure rollers are mounted on parallel rotary shafts, respectively, wherein the die roller includes a contoured surface;

FIGS. 3 through 5 show serial steps of the present process that includes feeding of a first layer of a first polymeric material between the die and pressure rollers of the cutting mechanism and cutting the contoured surface in the first layer;

FIG. 6 is a perspective view of the sound insulating pad formed by the steps of the process of the present invention;

FIG. 7 is a perspective view of a section blank formed by the steps of the process of the present invention; and

FIG. 8 is a cross sectional view of a fire-wall including a sound insulating pad connected to the fire-wall and a plurality of various cables extending through the fire-wall and the sound insulating pad.

### DETAILED DESCRIPTION OF THE INVENTION

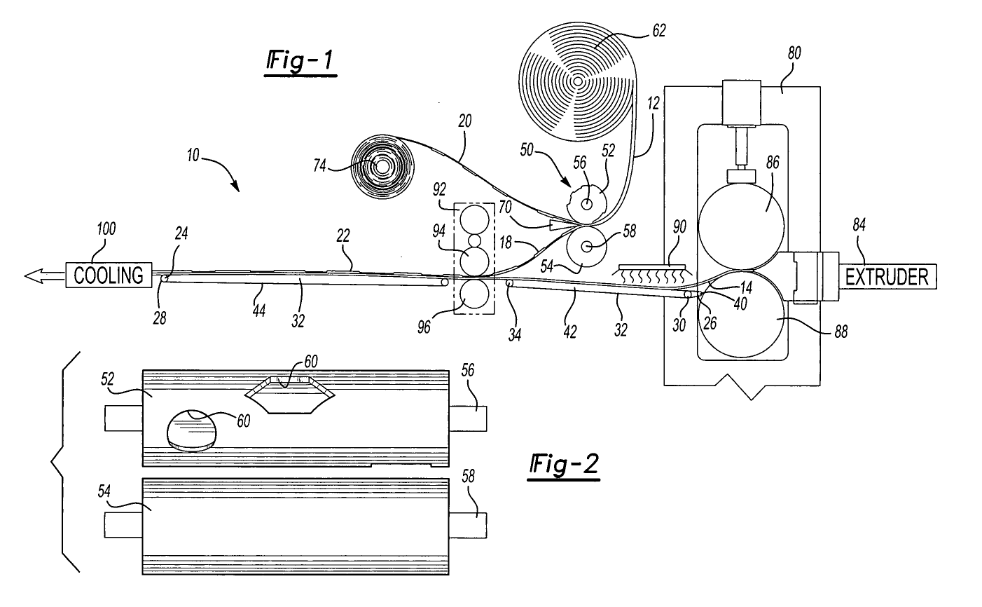

Referring to the FIGS. 1 through 8, wherein like numerals indicate like or corresponding parts throughout the several views, an assembly for fabricating a pad of a polymeric material having three dimensional contoured surface is generally shown at 10.

Referring to FIG. 1, the assembly 10 is designed to perform and accommodate the steps of the fabricating process that includes supplying a first layer 12 of a first polymeric material and the step of supplying a second layer 14 of a second polymeric material, followed by serially removing blanks 18 of the first polymeric material from the first layer 12 to produce an excess layer 20 of the first polymeric material removed from the first layer 12 and a useable layer 72 having expanded sections, i.e. the blanks 18 separated by the compacted sections. When the excess layer 20 is formed, the excess layer 20 containing the blanks 18 and uncompacted sections is collected by a collection barrel 74. The useable layer 72 of the first polymeric material is serially disposed along the second layer 14 of the second polymeric material. The blanks 18 of the first polymeric material are disposed upon the second layer 14 of the second polymeric material, by fusing the blanks 18 of the useable layer 72 of the first polymeric material to the second layer 14 of the second polymeric material to receive a contoured layer or laminated layer 22.

Referring back to FIG. 1, the assembly 10, i.e. the conveyor assembly 10 includes a frame (not shown) having terminal ends 24, 26 and a gear 28 at one end 24 and a roller 30 at the other terminal end 26. The conveyor assembly 10 includes a first section 32 having first 34 and second 40 ends and a continuous belt loop 42 disposed about the ends 34, 40. The conveyor assembly 10 includes a second section 44, which includes a frame and a plurality of rollers, mechanically engaged within the frame. Those skilled in the art will appreciate that the conveyor assembly 10 employs a motor (not shown) to rotate the gear and to move the belt loop 42 in a continuous cycle.

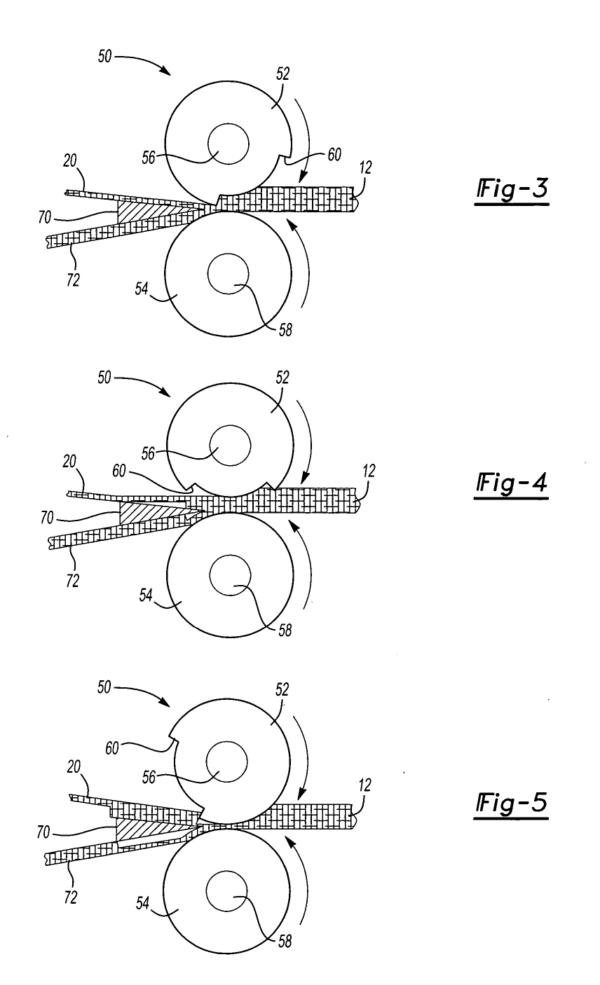

As best shown in FIGS. 3 through 5, the conveyor assembly 10 includes a cutting mechanism, generally shown at 50, adjacent the conveyor assembly 10, for serially removing the blanks 18 of the first polymeric material form the first layer 12. The cutting mechanism 50 includes a frame (not shown) having die 52 and pressure 54 rollers of a generally circular configuration, as viewed in cross section. The die 52 and pressure 54 rollers are mounted on parallel rotary shafts 56, 58, respectively, and adjacent one the other. The die 52 and pressure 54 rollers are positioned vertically with respect to one the other and defining a gap between the die 52 and pressure 54 rollers, enough to receive the first layer 12 of the first polymeric material.

The die roller 52 includes at least one depression 60 defined therein for serially compacting the first layer 12 of the first polymeric material, i.e. foamed or fibrous polymeric material, between spaced uncompacted sections to define interleaved compacted sections. When the die roller 52 and the pressure 54 roller are rotated into the opposite direction one from the other, the first layer 12 of the first polymeric material is automatically or manually fed from a source 62 adjacent the die 52 and pressure 54 rollers and to be compressed between the rollers 52, 54. When the die 52 and pressure 54 rollers are rotated, the first layer 12 is compressed between the die 52 and pressure 54 rollers. When the depression 60 is faced with the pressure roller 54, the first polymeric material of the first layer 12 expands from the compressed condition to the expanded condition by occupying and stuffing the space of the depression 60.

The cutting mechanism 50 includes a cutting edge 70, such as, for example a blade to cut the first layer 12 into the excess layer 20 having the uncompacted sections and the useable layer 72 having expanded sections formed from the compacted sections. The cutting edge 70 is oriented generally horizontal and perpendicular to the die 52 and pressure 54 rollers to slice the first layer 12 while still in the compressed state. When the die 52 and pressure 54 rollers are rotated into the opposite direction with respect to one the other, the first polymeric material of the first layer 12, which is expanded from the compressed condition to the expanded condition, while occupying the space of the depression 60, abuts against the cutting edge 70 thereby being razed by the cutting edge 70. The first polymeric material of the first layer 12, compressed between the die 52 and pressure 54 rollers and extending under the cutting edge 70, expands while being released from the compressed engagement between the die 52 and pressure 54 rollers in the form of the useable layer 72 having compacted and uncompacted sections. The excess layer 20 containing uncompacted sections is collected by a collection barrel 74, as shown in FIG. 1, rotated about an axis and positioned adjacent the cutting mechanism 50.

Referring again to FIG. 1, the conveyor assembly 10 includes an extruding mechanism 80 positioned at one of the terminal ends 26 of the conveyor assembly 10. The extruding mechanism 80 is designed for extruding and forming the second layer 14. The extruding mechanism 80 includes an extruder 84 for extruding the second polymeric material. The extruding mechanism 80 includes two calendar rollers 86, 88 adjacent the extruder 84 and positioned vertically with respect to each other. The calendar rollers 86, 88 receive the extruded second material from the extruder 84 and form the continues second layer 14 of the second polymeric material by compressing the extruded material between the calendar rollers 86, 88 as is known to those skilled in the art. The second layer 14 of the second polymeric material is heated by a heat source, such as, for example, an infra red assembly 90 prior to lamination to maintain fusible properties of the second layer 14.

A laminator 92 receives the second layer 14 of the second polymeric material delivered by the conveying surface 10 and the useable layer 72 of the first polymeric material from the cutting mechanism 50 for fusing the blanks 18 of the useable layer 72 of the first polymeric material to the second layer 14 of the second polymeric material. The laminator 92 includes two compression rollers 94, 96 adjacent one the other and positioned vertically with respect to one the other to define a contact point between the compression rollers 94, 96 to receive the lower and second 18 layers of the polymeric material. The compression rollers 94, 96 of the laminator 92 compress the useable layer 72 containing expanded compacted sections and the second layer 14 of the polymeric material to fuse the layers 72, 14 together to fabricate the laminated layer 22.

The conveyor assembly 10 includes cooling station 100 for cooling the laminated layer 22 before processing the laminated layer 22. With respect to various needs in the industry, the laminated layer 22 may be processed in different ways, i.e., and several embodiments. A first embodiment includes rolling (not shown) of the laminated layer 22 into a roller (not shown) to store or transport the roller to and in various industrial locations.

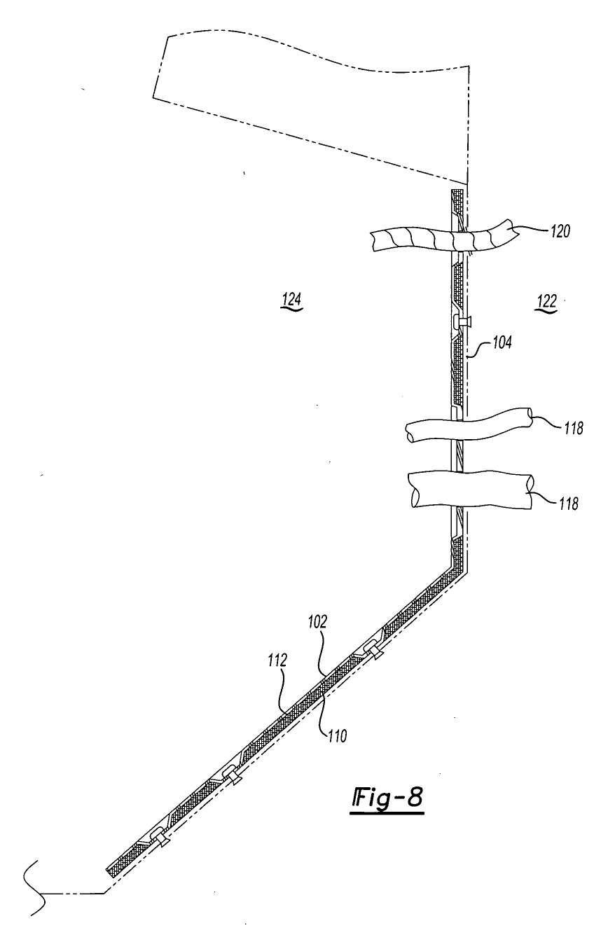

A second embodiment includes cutting the useable layer 72 of the first polymeric material into a plurality of pieces, such as, for example section blanks, generally shown at 108 and having various openings for mating with and to engage in complementary projections and ribs extending from the fire wall 104, as shown in FIG. 8. These section blanks 108 can optionally be shipped to another site for non-serial lamination with complementary section blanks formed from the second, non-foamed polymeric material, used to fabricate the second layer 14.

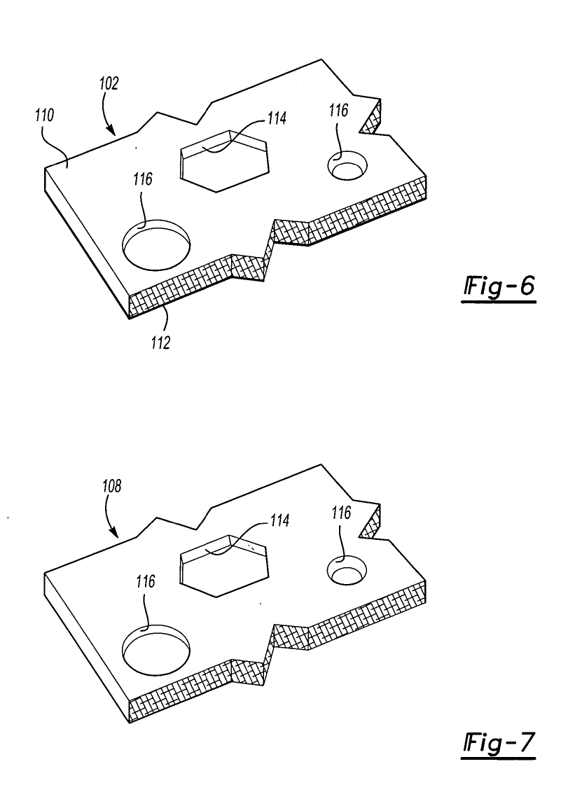

Still another alternative embodiment includes cutting the laminated layer 22 to a plurality of pieces or pads 102 (only one is shown in FIG. 6). The pads 102 present generally two-dimensional configuration adaptable to engage the planar surface of the fire wall 104. Those skilled in the art will appreciate that the contour of the fire wall 104 may include three dimensional configuration based on model, type, and size of the vehicle. To complement with the three dimensional configuration of the fire wall 104 and to engage in complementary projections and ribs extending from the fire wall 104 in various directions, the mat 102 is placed into a mold assembly (not shown) having a bottom section defining three dimensional opening and a press die having a contour complementary to the three dimensional opening of the bottom section. The pad 102 is placed into the three dimensional opening of the bottom section and compressed by the press die to fabricate the pad 102 having three dimensional contour to cooperably connect with a fire-wall 104, as shown in FIG. 8.

As shown in FIG. 6, the pad 102 fabricated by the process of the present invention includes top 110 and bottom 112 surface fused one with the other. The top surface 110 includes foam polymeric material. The bottom surface 112 is extruded from non-foamed polymeric material including EVA, TPO, PVC, and the like. The top surface 110 includes a plurality of apertures of rectangular configuration 114 and circular configuration 116. The apertures 114, 116 may extend through both top 110 and bottom 112 surfaces to receive tubes 118 and wires 120 extending from an engine compartment 122 through the firewall 104 and the pad 102 into a passenger compartment 124, as best shown in FIG. 8.

Those skilled in the art will appreciate that the apertures 114, 116 may also extend through the top surface 110 to mate with and to engage complementary projections and ribs formed by engine components located in the engine compartment 122 and fastened to the fire-wall 104. The pad 102 fabricated by the present process is efficient and provides for an improved sound insulating barrier that eliminates noise.

Obviously, many modifications and variations of the present invention are possible in light of the above teachings. The invention may be practiced otherwise than as specifically described within the scope of the appended claims. These antecedent recitations should be interpreted to cover any combination in which the incentive novelty exercises its utility.

1. A method of fabricating a pad of a polymeric material having three-dimensional contoured surface comprising the steps of;
supplying a first layer of a first polymeric material,
supplying a second layer of a second polymeric material,
serially removing blanks of material from the first layer to produce a useable layer,
collecting the blanks,
disposing the useable layer serially along the second layer,
fusing the useable layer to the second layer to provide a contoured layer.

2. A method as set forth in claim 1 wherein the step of serially removing the blanks of the material from the first layer is further defined as serially compacting the first layer between spaced uncompacted sections to define interleaved compacted sections.

3. A method as set forth in claim 2 wherein the step of serially removing the blanks of the material from the first layer is further defined as cutting the first layer into an useable layer containing the uncompacted sections and a lower layer having expanded compacted sections defining the blanks.

4. A method as set forth in claim 3 including laminating the lower layer onto said second layer to fuse the blanks to the second layer.

5. A method as set forth in claim 4 including the step of heating the second layer prior to lamination.

6. A method as set forth in claim 5 wherein the step of laminating the lower layer onto the second layer is further defined as pressing the lower layer onto the second layer.

7. A method as set forth in claim 6 including extruding the second layer of the second polymeric material.

8. A method as set forth in claim 7 including cooling the laminated second and lower layers.

9. A three dimensional noise reducing barrier having a foamed layer and a barrier layer formed from the steps of:
providing a generally planar sheet of said foamed layer;
providing a second generally planar sheet of said barrier layer;
forming contours in said generally planar sheet of said foamed layer corresponding to a desired three dimensional configuration of said noise reducing barrier;
adhering said foamed layer having contours formed therein to said second layer thereby forming a laminate; and
forming said laminate into a three dimensional configuration thereby locating said contours formed in said generally planar sheet of said foamed layer in a desired three dimensional location.

10. A noise reducing barrier as set forth in claim 9, wherein said laminate defines apertures therethrough.

11. A pad as set forth in claim 9, wherein said foamed layer includes a lower density than said barrier layer.

12. A pad as set forth in claim 9, wherein said foamed layer is formed from polyurethane.

13. A pad as set forth in claim 9, wherein said barrier layer comprises reclaimed polymers having a density greater than said foamed layer.

14. A method of forming an acoustical barrier, comprising the steps of:
providing a first layer of material and a second layer of material having a density greater than said first layer of material, wherein said first and said second layers of material are provided in a generally planar configuration;
bisecting said first layer of material thereby forming a contoured surface in said first layer of material corresponding to a desired three dimensional configuration;
laminating said first layer of material to said second layer of material thereby forming a laminate; and
molding said laminate into said desired three dimensional configuration thereby locating said contours formed in said first layer in a desired three dimensional location.

15. The method as set forth in claim 14, wherein said step of bisecting said first layer of material is further defined by cutting said first layer of material.

16. The method as set forth in claim 15, wherein said step of cutting said first layer of material is further defined by compressing said first layer of material into a configuration opposite from said contoured surface corresponding to said desired three dimensional configuration.

17. The method as set forth in claim 14, further including the step of extruding said second layer of material into a generally planar sheet.

18. The method as set forth in claim 14, wherein said step of providing a first layer of material and a second layer of material comprises providing continuous sheets of material.

19. The method as set forth in claim 14, wherein said step of providing a first layer of material and a second layer of material comprises providing separate sheets of material.

20. The method as set forth in claim 14, further including the step of heating said second layer of material prior to forming said laminate.

21. The method as set forth in claim 14, further including the step of cooling said laminate.
